(19) United States
(12) Patent Application Publication
(10) Pub. No.: US 2020/0320871 A1
(43) Pub. Date: Oct. 8, 2020

(54) TRAFFIC MANAGEMENT SYSTEMS AND METHODS WITH INTEGRATED SENSOR MAINTENANCE

(71) Applicant: Siemens Mobility, Inc., New York, NY (US)

(72) Inventors: Glenn Massarano, Berkeley, CA (US); Martin Sehr, Kensington, CA (US)

(21) Appl. No.: 16/375,240

(22) Filed: Apr. 4, 2019

(51) Int. Cl. G08G 1/08; G08G 1/095; G08G 1/01

(52) U.S. Cl. CPC G08G 1/08; G08G 1/0116; G08G 1/0145; G08G 1/095

(57) ABSTRACT

A traffic management system includes a traffic sensor network with a plurality of sensors providing sensor data, a traffic management unit with a data collection module, a sensor quality analytics module, and a decision support module, and one or more processors configured via executable instructions to collect the sensor data of the traffic sensor network via the data collection module, determine relative weights of the plurality of sensors based on operating states of the plurality of sensors and the sensor data via the sensor quality analytics module, and output traffic signal controlling information and sensor maintenance information based on the relative weights of the plurality of sensors via the decision support module. Further, traffic controllers and a method for managing traffic in combination with the traffic management system are described.

### BACKGROUND

### 1. Field

Aspects of the present disclosure generally relate to traffic management systems and associated methods with integrated sensor maintenance.

### 2. Description of the Related Art

Traffic control systems are used to govern operation of traffic signals at signaled intersections through the use of signal plans. Traffic control systems comprise a traffic controller, wherein the traffic control system may simply be referred to as traffic controller. Traffic controllers traditionally either operate in isolation or are monitored and controlled by a central control system that communicates with the traffic controller. For traffic controllers that operate in isolation, the signal plans that govern operation of the traffic signals may be manually entered and may be modified through a physical user interface on the traffic controllers. For traffic controllers that are monitored and controlled by a central control system, signal plans for the traffic signals may be entered and modified through the central control system.

Modern traffic management solutions rely heavily on reliable real-time sensor data to adjust traffic signal decisions accordingly to maintain overall system performance at a satisfactory level. Sensor performance and availability thus play an inherently critical role in traffic management, in particular for arterial corridors near peak traffic hours. In practice, many traffic sensors currently deployed are prone to faults and in many cases require significant resources to be maintained, for instance when replacing underground vehicle detectors. Thus, there may exist a need to both identify correctly those faulty sensors that have the highest impact on overall system level performance as well as to manage constrained resources to maintain critical sensor hardware.

### SUMMARY

Briefly described, aspects of the present disclosure relate to a traffic management system and a method for managing traffic.

A first aspect of the present disclosure provides a traffic management system comprising a traffic management system comprising a traffic sensor network comprising a plurality of sensors providing sensor data, a traffic management unit comprising a data collection module, a sensor quality analytics module, and a decision support module, and at least one processor configured via executable instructions to collect the sensor data of the traffic sensor network via the data collection module, determine relative weights of the plurality of sensors based on operating states of the plurality of sensors and the sensor data via the sensor quality analytics module, and output traffic signal controlling information and sensor maintenance information based on the relative weights of the plurality of sensors via the decision support module.

A second aspect of the present disclosure provides a method for managing traffic comprising through operation of at least one processor: collecting sensor data provided by a traffic sensor network comprising a plurality of sensors, determining relative weights of the plurality of sensors based on operating states of the plurality of sensor and the sensor data, and outputting traffic signal controlling information and sensor maintenance information based on the relative weights of the plurality of sensors.

A third aspect of the present disclosure provides a traffic controller in combination(s) with a traffic management system as described herein.

A fourth aspect of the present disclosure provides a non-transitory computer readable medium encoded with processor executable instructions that when executed by at least one processor, cause the at least one processor to carry out a method for managing traffic as described herein.

### BRIEF DESCRIPTION OF THE DRAWINGS

FIG. 1 illustrates a schematic diagram illustrating an intersection in accordance with an exemplary embodiment of the present disclosure.

FIG. 2 illustrates a schematic diagram of a traffic management system in accordance with an exemplary embodiment of the present disclosure.

FIG. 3 illustrates a schematic diagram of a traffic controller in accordance with an exemplary embodiment of the present disclosure.

FIG. 4 illustrates a flow chart of a method for managing traffic in accordance with an exemplary embodiment of the present disclosure.

### DETAILED DESCRIPTION

To facilitate an understanding of embodiments, principles, and features of the present disclosure, they are explained hereinafter with reference to implementation in illustrative embodiments. In particular, they are described in the context of being a traffic management system and associated method and traffic controller. Embodiments of the present disclosure, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

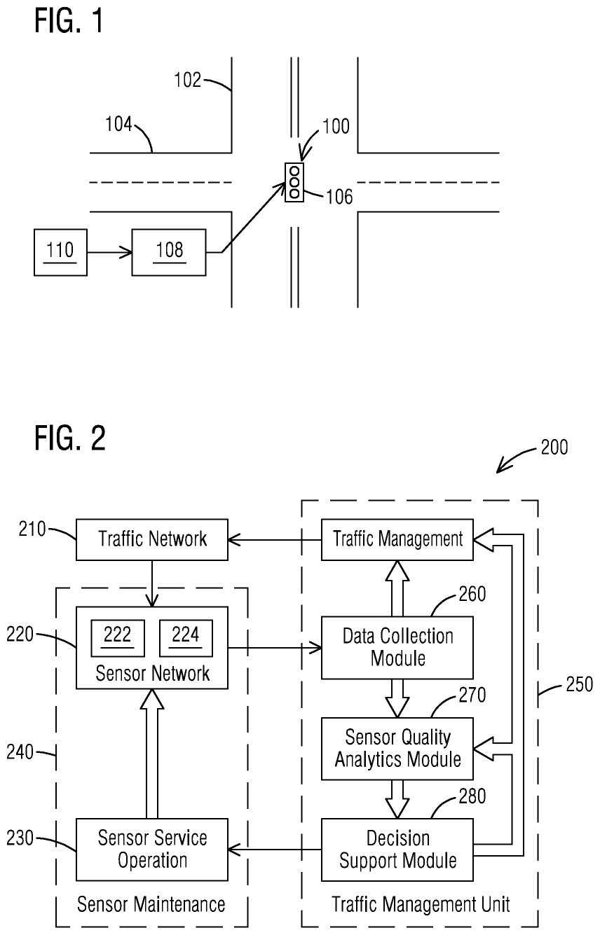

FIG. 1 illustrates a schematic diagram illustrating an intersection 100 in accordance with an exemplary embodiment of the present disclosure. As illustrated, the intersection 100 of a main street 102 and a side street 104 includes a traffic signal 106 that is configured to control the flow of vehicles through the intersection 100. The traffic signal 106 is controlled by a traffic controller 108. In exemplary embodiments, the traffic controller 108 is connected to a network 110. The network 110 may be for example a private or secure network that is connected to the traffic controller 108 by a fiber optic cable, copper wire, a cellular modem or other wireless network, or by other suitable means. In exemplary embodiments, the traffic controller 108 may receive signal control plans via the network 110 which are used to govern the operation of the traffic signal 106. The traffic controller 108 is typically housed in a large metal cabinet, known as “traffic controller cabinet” or “TCC”, typically located in proximity to the intersection.

The traffic signal, traffic controller 108 and network 110 can be components of a traffic management system. It should be noted that a traffic management system may comprise multiple traffic signals 106 and other signals which may include for example railroad signals etc.

FIG. 2 illustrates a schematic diagram of a traffic management system 200 in accordance with an exemplary embodiment of the present disclosure.

As described before, modern traffic management solutions rely heavily on reliable real-time sensor data to adjust traffic signal decisions accordingly to maintain overall system performance at a satisfactory level. Sensor performance and availability thus play an inherently critical role in traffic management, specifically for arterial corridors near peak traffic hours. In practice, many traffic sensors currently deployed are prone to faults and in many cases require significant resources to be maintained, for instance when replacing underground vehicle detectors.

An integrated approach to sensor quality maintenance for traffic management systems that addresses different needs simultaneously is provided. For example, the traffic management system 200 includes one or more sensor network(s) and additional traffic infrastructure such as communication networks enabling data exchange between various sensors deployed in the traffic infrastructure. The traffic management system 200 allows a joint operation of traffic signals and road sensor hardware.

In an exemplary embodiment, the traffic management system 200 comprises a traffic network 210, specifically a road traffic network 210. A road traffic network 210 as used herein refers to infrastructure including highways, roads, streets etc. utilized by road vehicles, such as cars, trucks, buses etc. travelling on the highways, roads, streets etc. as well as traffic signals, such as traffic lights 106, and traffic control devices, such as traffic controllers 108, see for example FIG. 1. In another embodiment, the traffic network 210 may further include for example railroad tracks and railroad signals as infrastructure.

The traffic network 210 is equipped with and/or in communication with a sensor network 220 with a collection of sensors observing various traffic indicators and patterns. The sensor network 220 comprises a plurality of sensors including for example vehicle detection sensors 222 providing vehicle detection data and vehicle travel data. Vehicle detection sensor include but are not limited to inductive loops, micro-loops, video devices, pneumatic sensors, radar, laser, or microwave devices. However, the sensor network may also include sensors 224 providing data of the environment of the traffic network 210, such as for example weather data, wherein weather sensors provide weather data (temperatures, precipitation etc.) of for example highways in weather critical locations. It should be noted that the sensor network 220 may comprise further sensors which may be useful for traffic management.

Functionality of the sensor network 220 is upheld and supported by sensor service operation 230. Generally, service operation ensures efficient delivery of services without interruptions. In our example, the sensor service operation 230 ensures that the plurality of sensors 222, 224 of sensor network 220 are operating and functioning properly and deliver the expected sensor data. Sensor service operation 230 further includes that sensors 222, 224 are serviced according to a service schedule and that faulty sensors 222, 224 are detected and replaced.

The sensor service operation 230 and sensor network 220 are arranged or organized under sensor maintenance 240. In practice, sensor maintenance 240 may be represented by a party or provider responsible for the traffic infrastructure, for example the traffic network 210.

The traffic network 210 is connected to the sensor network 220 in that the traffic network 210 provides the infrastructure and vehicles utilized by the sensor network 220 for measuring and providing sensor data.

The traffic management system 200 further comprises traffic management unit 250 comprising multiple digital support tools. Traffic management unit 250 comprises primarily software components but may also comprise hardware components. The traffic management unit 250 is twofold in combining both a deployed traffic management 290 as well as components configured to facilitate sensor health of the sensors 222, 224 and performance analysis and management with overall system performance in mind.

In an exemplary embodiment, the traffic management unit 250 comprises digital support tools including data collection module 260, sensor quality analytics module 270 and decision support module 280 as well as at least one processor 252. The modules 260, 270, 280 comprise software, i.e. instructions executable by the at least one processor 252.

In operation, the traffic management unit 250 receives and collects sensor data via the data collection module 260, accessing the sensor data provided by the sensor network 220. Sensors 222 provide vehicle detection data and vehicle travel data, and sensors 224 provide data of surroundings or environment of the traffic network 210, such as weather data.

The data collection module 260 (pre-)processes the collected data for both the traffic management 290 as well as the sensor quality analytics module 270. The data collection module 260 provides the collected data to the traffic management 290 and to the sensor quality analytics module 270.

Traffic management (module) 290 is utilized to control and/or manage the traffic network 210, for example to control traffic signals 106 based on collected sensor data.

The sensor quality analytics module 270 may receive different data than the traffic management 290. For example, the sensor quality analytics module 270 may receive more data for analysis than traffic management 290 for managing/controlling the traffic network 210 because not all the collected data may be necessary for managing/controlling traffic.

The sensor quality analytics module 270 evaluates the collected data, for example tracks comprehensive performance metrics of the overall sensor network 220 on a system level, with relative weights (e.g., priorities) placed on health states of various sensors 222, 224 depending on their ability to compromise overall traffic network performance as well as potentially arising maintenance costs.

In an embodiment, the sensor quality analytics module 270 is configured to determine relative weights of the plurality of sensors 222, 224 based on operating states of the plurality of sensors 222, 224 and the sensor data. Based on the relative weights of the plurality of sensors 222, 224, traffic signal controlling information and sensor maintenance information is output via the decision support module 280.

Operating states of the plurality of sensors 222, 224 include for example a first operating state for faulty sensors and a second operating state of healthy sensors.

The relative weights of the sensors 222, 224 are based on the operating states and on vehicle detection data and vehicle travel data. For example, based on the collected vehicle detection/travel data and environmental data, the operating states (faulty or healthy) of the sensors 222, 224 are determined, for example by comparing the delivered sensor data to previously collected and stored data provided by a specific sensor. This way, the sensors 222, 224 are at least divided in two categories faulty and healthy. It should be noted that the operating states may comprise further states or be more granular in addition to just faulty and healthy, for example healthy with restrictions, such as trusting a sensor's data with a certain confidence interval etc. Even the ‘faulty’ state itself may reflect specific types of possible faults, wherein decisions may be based on a specific type of fault by the other subsystems, e.g. decision support module 280.

In addition to the operating states of the sensors 222, 224, the vehicle detection and travel data are utilized to determine the relative weights. For example, a faulty sensor located in a high traffic area receives a higher relative weight than a faulty sensor in a low traffic area. This way, the faulty sensor in the high traffic area will be prioritized for service and replacement that the faulty sensor (which may be the same type of sensor) in a low traffic area. For example, inductive loops in a large and busy intersection receive higher or greater relative weight than inductive loops in a small village intersection with very little traffic. Thus, the (faulty) inductive loops of the large and busy intersection may be repaired and serviced first because of their greater impact to the overall traffic system. Another aspect of a service scheduling process includes that replacement or maintenance of sensors 222, 224 in high traffic areas (e.g., busy intersections) cause a higher relative cost compared to the actual replacement operation, because traffic may be compromised further by road work/construction during repair/maintenance of sensors, i.e. trade-off of the service scheduling process.

Further, the environmental data, such as weather data, may also be considered when determining the relative weights of the sensors 22, 224. For example, sensors in weather critical areas may be prioritized over sensors in not critical areas.

The analytics and metrics data of the sensor analytics module 270 are made available to the decision support module 280. The decision support module 280 may either be configured to access the analytics data of the sensor analytics module 270 or the analytics data are provided to the decision support module 280.

The decision support module 280 provides sensor maintenance information and is configured, via the at least one processor 252, to output service requests for faulty sensor in a prioritized order based on the previously determined relative weights of the sensors 222, 224 (schedule service operation). Further, the decision support module 280 is configured to update the operating status and/or relative weights of the sensors 222, 224, for example after service has been performed on sensors. For example, after a sensor (inductive loop) has been repaired and is working properly, its operating status is changed to healthy and its relative weight decreased because service is no longer needed.

The decision support module 280 is further configured to provide information for a traffic controller (see for example 108 in FIG. 1) for real-time controlling of traffic signals (see 106 in FIG. 1). For example, the traffic management (module) 290 is utilized to control and/or manage the traffic network 210, for example to control traffic signals 106 based on collected sensor data. In an example, red- or green-phases of a traffic signal 106 may be adapted based on collected vehicle detection data by the traffic management 290.

Notice that in practice, the components and processes relating to evaluating sensor quality and supporting, e.g. providing or outputting, decisions, such as sensor quality analytics module 270 and decision support module 280 may operate on a slower time-scale compared with the traffic management tools, such as traffic management 290 and traffic network 210.

In an embodiment, the decision support module 280 may be configured as module comprising artificial intelligence (AI) including instructions and/or machine learning algorithms which enable the module 280 to make appropriate decisions, utilizing for example neural network(s) and/or deep learning mechanism(s) and/or other supervised learning techniques.

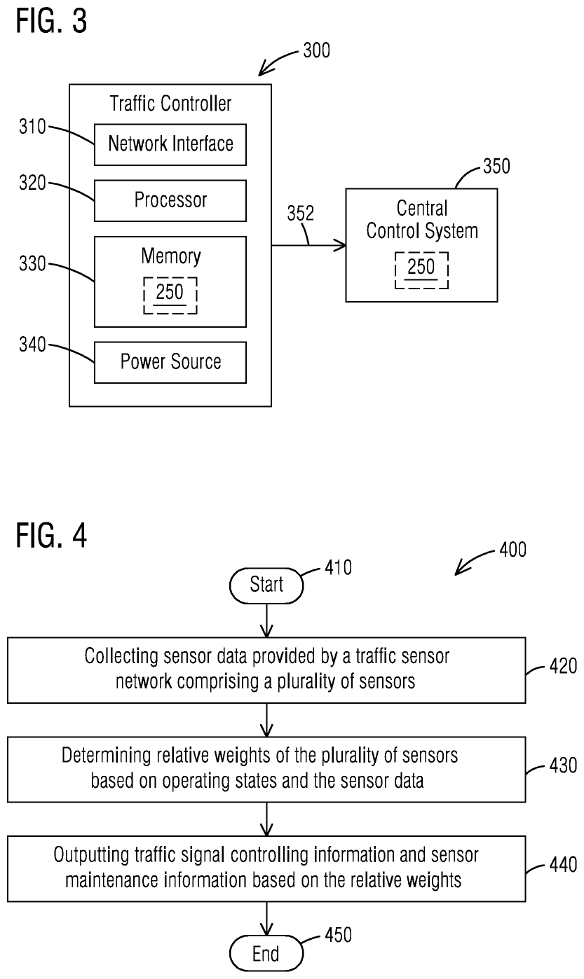

FIG. 3 illustrates a schematic diagram of a traffic controller 300 in accordance with an exemplary embodiment of the present disclosure. As illustrated, the traffic controller 300 is enhanced with traffic management tools (digital support tools) such as traffic management unit 250.

Generally, the traffic controller 300 includes a network interface 310, a processor 320, a memory 330, and a power source 340. In exemplary embodiments, the memory 330 may include any of a wide variety of memory devices including volatile and non-volatile memory devices. In exemplary embodiments, the processor 320 may include one or more processing units.

The memory 330 of the traffic controller 300 includes software that includes a variety of applications. One of the applications is traffic control software that controls and monitors the connected traffic signal(s) based on a stored signal plan and/or external detectors such as vehicle and pedestrian detectors. This application may be the traffic management (module) 290 as described for example in FIG. 2.

Another application stored in memory 330 may comprise the traffic management unit 250 with modules 260, 270, 280. In this example, the traffic controller 300 is configured to carry out the sensor analytics and sensor/traffic management, e.g. collect and analyze sensor data and provide output options as described for example with reference to FIG. 2.

In another embodiment, the network interface 310 is configured to connect the enhanced traffic controller 300 to a communications network 352, wired or wireless, for example via an Ethernet cable or other suitable means to connect with a central traffic control system 350 remotely, wherein the central control system 350 stores the traffic management unit 250. In this case, the traffic controller 300 is configured to exchange information with the central control system 350 via the communications network 352, and to use the processor 320 and memory 330 to process and store received information. For example, the traffic controller 330 may be configured to collect the sensor data from the sensor network 220, transmit collected sensor data to the central control system 350, and receive traffic management information from the central control system 350. The central control system 350 comprising the traffic management unit 250 carries out the data analytics and provides decisions. The central traffic control system 350 may receive and process data from multiple traffic controllers at various locations, wherein the data from the various traffic controllers may be combined and processed in view of the overall data and system.

As described, the traffic controller 300 or the central traffic control system 350 may comprise the traffic management unit 250. In another embodiment, the traffic controller 300 and central control system 350 may share functionalities of the traffic management unit 250. For example, the traffic controller 300 may comprise the data collection module 260, whereas the central control system 350 comprises the sensor quality analytics module 270 and decision support module 280. Thus, the traffic management unit 250 is illustrated in broken lines in FIG. 3.

Those of skill in the art will recognize that not all details are shown in the simplified block diagram of FIG. 3. The processor 320 may be configured to perform only the processes described herein or can also be configured to perform other processes for the operation and management of the traffic controller 300. The various components of the traffic controller 300 and the software thereon, may be configured as separate elements connected to communicate with each other or two or more of these components could be integrated into a single device.

FIG. 4 illustrates a flow chart of a method 400 for managing traffic in accordance with an exemplary embodiment of the present disclosure. While the method 400 is described as being a series of acts that are performed in a sequence, it is to be understood that the method 400 may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

The method 400 may start at 410 and may include an act 420 of collecting sensor data provided by a traffic sensor network 220 comprising a plurality of sensors 222, 224, and an act 430 of determining relative weights of the plurality of sensors 222, 224 based on operating states of the plurality of sensors 222, 224 and based on the sensor data. The method 400 may also include an act 440 of outputting traffic signal controlling information and sensor maintenance information based on the relative weights of the plurality of sensors 222, 224. At 450, the method 400 may end.

It should be appreciated that this described method 400 may include additional acts and/or alternative acts corresponding to the features described previously with respect to the traffic management system 200 and traffic controller 300 (see FIG. 2 and FIG. 3).

In an embodiment, the method 400 may further include an act of updating the operating status and/or the relative weights of the plurality of sensors 222, 224 after performing service of faulty sensors 222, 224.

In another embodiment, the method 400 may further include an act of transmitting the operating status and/or relative weights of the plurality of sensors 222, 224 to a central traffic control system 350.

It should be appreciated that acts associated with the above-described methodologies, features, and functions (other than any described manual acts) may be carried out by one or more data processing systems, such as for example traffic controller 200 or central control system 300, via operation of at least one processor 252, 320, respectively. As used herein a processor corresponds to any electronic device that is configured via hardware circuits, software, and/or firmware to process data. For example, processors described herein may correspond to one or more (or a combination) of a microprocessor, CPU, or any other integrated circuit (IC) or other type of circuit that is capable of processing data in a data processing system. As discussed previously, the processor 252, 320 that is described or claimed as being configured to carry out a particular described/claimed process or function may correspond to a CPU that executes computer/processor executable instructions stored in a memory in form of software and/or firmware to carry out such a described/claimed process or function. However, it should also be appreciated that such a processor may correspond to an IC that is hard wired with processing circuitry (e.g., an FPGA or ASIC IC) to carry out such a described/claimed process or function.

In addition, it should also be understood that a processor that is described or claimed as being configured to carry out a particular described/claimed process or function may correspond to the combination of the processor 252, 320 with the executable instructions (e.g., software/firmware apps) loaded/installed into a memory (volatile and/or non-volatile), which are currently being executed and/or are available to be executed by the processor 252, 320 to cause the processor 252, 320 to carry out the described/claimed process or function. Thus, a processor that is powered off or is executing other software, but has the described software installed on a data store in operative connection therewith (such as on a hard drive or SSD) in a manner that is setup to be executed by the processor (when started by a user, hardware and/or other software), may also correspond to the described/claimed processor that is configured to carry out the particular processes and functions described/claimed herein.

In addition, it should be understood, that reference to “a processor” may include multiple physical processors or cores that are configures to carry out the functions described herein. Further, it should be appreciated that a data processing system may also be referred to as a controller that is operative to control at least one operation.

It is also important to note that while the disclosure includes a description in the context of a fully functional system and/or a series of acts, those skilled in the art will appreciate that at least portions of the mechanism of the present disclosure and/or described acts are capable of being distributed in the form of computer/processor executable instructions (e.g., software and/or firmware instructions) contained within a data store that corresponds to a non-transitory machine-usable, computer-usable, or computer-readable medium in any of a variety of forms. The computer/processor executable instructions may include a routine, a sub-routine, programs, applications, modules, libraries, and/or the like. Further, it should be appreciated that computer/processor executable instructions may correspond to and/or may be generated from source code, byte code, runtime code, machine code, assembly language, Java, JavaScript, Python, Julia, C, C#, C++ or any other form of code that can be programmed/configured to cause at least one processor to carry out the acts and features described herein. Still further, results of the described/claimed processes or functions may be stored in a computer-readable medium, displayed on a display device, and/or the like.

1. A traffic management system comprising:
a traffic sensor network comprising a plurality of sensors providing sensor data,
a traffic management unit comprising a data collection module, a sensor quality analytics module, and a decision support module, and
at least one processor configured via executable instructions to
collect the sensor data of the traffic sensor network via the data collection module,
determine relative weights of the plurality of sensors based on operating states of the plurality of sensors and the sensor data via the sensor quality analytics module, and
output traffic signal controlling information and sensor maintenance information based on the relative weights of the plurality of sensors via the decision support module.

2. The traffic management system of claim 1, wherein the traffic sensor network comprises vehicle detection sensors providing vehicle detection data and vehicle travel data.

3. The traffic management system of claim 1, wherein the traffic sensor network comprises sensors providing environmental data.

4. The traffic management system of claim 1, wherein the operating states include a first operating state for faulty sensors and a second operating state for healthy sensors of the plurality of sensors.

5. The traffic management system of claim 4, wherein the relative weights of the plurality of sensors are based on the operating states and on vehicle detection data and vehicle travel data.

6. The traffic management system of claim 4, wherein the sensor maintenance information comprises service requests for faulty sensors of in a prioritized order based on the relative weights of the plurality of sensors.

7. The traffic management system of claim 4, wherein the at least one processor is further configured to, via the decision support module, update the operating status and/or relative weights of the plurality of sensors after performed service of the faulty sensors.

8. The traffic management system of claim 1, wherein traffic signal controlling information comprises information for a traffic controller for real-time traffic controlling of traffic signals.

9. A traffic controller comprising:
at least one processor configured to control operation of a traffic signal based on signal control plans stored in a memory, and to receive sensor data provided by a plurality of sensors of a traffic sensor network, and
a traffic management unit as claimed in claim 1.

10. The traffic controller of claim 9, further comprising:
a network interface configured to connect to a central traffic control system via a communication network.

11. The traffic controller of claim 10, wherein the at least one processor is further configured to transmit the sensor maintenance information including one or more service requests for the plurality of sensors in a prioritized order based on the relative weights of the plurality of sensors to the central traffic control system for further processing.

12. A traffic controller comprising:
at least one processor configured to control operation of a traffic signal based on signal control plans stored in a memory, and to receive sensor data provided by a plurality of sensors of a traffic sensor network, and
a network interface configured to connect to a central traffic control system via a communication network,
wherein the at least on processor is configured to transmit collected sensor data to the central control system, and to receive information from the central traffic control system to update the signal control plans based on the collected sensor data.

13. The traffic controller of claim 12, wherein the information received from the central traffic control system comprises information for real-time traffic controlling of traffic signals.

14. A method for managing traffic comprising through operation of at least one processor:
collecting sensor data provided by a traffic sensor network comprising a plurality of sensors;
determining relative weights of the plurality of sensors based on operating states of the plurality of sensor and the sensor data, and
outputting traffic signal controlling information and sensor maintenance information based on the relative weights of the plurality of sensors.

15. The method of claim 14, wherein outputting sensor maintenance information includes service requests for the plurality of sensors in a prioritized order based on the relative weights of the plurality of sensors.

16. The method of claim 15, further comprising:
updating the operating status and/or the relative weights of the plurality of sensors after performing service of faulty sensors.

17. The method of claim 14, wherein outputting traffic signal controlling information includes information for a traffic controller for real-time traffic controlling of traffic signals.

18. The method of claim 14, further comprising:
transmitting the operating status and/or relative weights of the plurality of sensors to a central traffic control system.

19. The method of claim 14, wherein the plurality of sensors provides vehicle detection data, vehicle travel data and environmental data.

20. A non-transitory computer readable medium encoded with processor executable instructions that when executed by at least one processor, cause the at least one processor to carry out a method for managing traffic according to claim 14.
